(19) United States
(12) Patent Application Publication
(10) Pub. No.: US 2002/0166758 A1
(43) Pub. Date: Nov. 14, 2002

(54) Evaporation process for producing high-quality drinking water and high-grade brine from any-grade salt water

(76) Inventor: Peter Vinz, Garmisch-Partenkirchen (DE)

Correspondence Address: BANNER & WITCOFF, 1001 G STREET N W, SUITE 1100, WASHINGTON, DC, 20001, US

(21) Appl. No.: 10/188,197

(22) PCT Filed: Oct. 26, 2001
(86) PCT No.: PCT/DE01/04072

(30) Foreign Application Priority Data
May 2, 2001 (DE) 101 21 374.3

(51) Int. Cl. B01D 3/42; C02F 1/16; C02F 1/04

(52) U.S. Cl. 203/2; 159/16.1; 159/23; 159/46; 159/8; 159/901; 203/22; 203/27; 203/49; 203/71; 203/8; 203/17; 203/20; 202/160; 202/173; 202/176

(57) ABSTRACT

The invention consists of a cost-effective process and facilities for obtaining high quality drinking water and high-grade brine as a chemical raw material from raw water regardless of how much salt it contains. When combined with a thermal power-generation process, the plant also produces electric power with a fuel utilization of over 85%.

The applied evaporation process using waste heat works with a water vapor-saturated air circulation across a range of temperatures with recuperative preheating of the salt water. Plants like this can consist of a large number of evaporation modules and thus be adjusted according to any demand of high quality drinking water. The evaporation modules work at up to 4 system pressure levels and can use the waste heat of the higher system pressure levels in the subsequent system pressure levels.

Heat consumption values of less than 10 kWh per m³ of drinking water can thus be achieved. The modular design and the use of commercially available gas turbines/generator sets are allowing a performance range from 3.0 m³ to 1000 m³ of high quality drinking water per hour. Lower rates of drinking water production can be obtained using the waste heat from combustion engines.

The invention constitutes an evaporation process and a number of advantageous developments of the process for producing high quality drinking water and high-grade brine as a chemical raw material from raw water regardless of its initial salt content. If the evaporation process is combined with a thermal power generation process, the combination plant produces electric power at highly efficient rates of fuel utilization.

The process constituting the invention employs a vapor-saturated circulatory flow of carrier gas across one or more evaporation/condensation temperature ranges. These are arranged one above the other. The carrier gas is absorbing water vapor in an evaporation column and is releasing it in a condensation column, thus producing a distillate. The raw water fed in is serving as a coolant. It is heating up, when it absorbs the heat, that is generated by the condensation of the distillate. Additional thermal measures are compensating the heat losses transferred by the circulation of the carrier gas.

An evaporation process like this consisting of an evaporation unit is described in EP 0531 293 B1, in which, to compensate for heat losses transferred with the carrier gas, two heat exchange devices with identical performance are used, through which all of the circulating carrier gas passes. One of these heat exchange devices is located in the condensation column and the other in the evaporation column. The purpose of this is to heat up the vapor-depleted total flow of carrier gas in the condensation column by using condensation heat and transferring the absorbed heat in the evaporation column back to the evaporating medium, thus counteracting the heat losses transferred.

The main problems with this method are that these additional heat exchange devices greatly overcompensate for the heat losses transferred, and that there are considerable temperature losses resulting from multiple heat transfer. Moreover, the mechanical integration of these heat exchange devices in both columns is complex in structure, takes up a lot of space and is also production-intensive and costly.

The solution to the problem provided by the invention avoids the overcompensation of the heat losses transferred by the carrier gas. It is based on the specified evaporation plant and consists of an evaporation column, a condensation column, a reheating facility and a circulation of the carrier gas in which the vapor-collecting carrier gas, propelled by a blower, is circulating across an identical evaporation/condensation temperature range, with temperature and quantity adjustments, through and between the evaporation column and the condensation column. A recuperative heat exchange device through which the raw water passes is located in the condensation column.

Instead of the heat exchange devices integrated additionally in the columns to heat up and cool down the entire flow of the circulating vapor-depleted carrier gas, the solution represented by the invention employs a heat exchanger consisting of several cells between the condensation column and the evaporation column. On the primary side an allocated, vapor-saturated, transferred flow of carrier gas is passing through each of these heat exchanger cells. On the secondary side, salt water is passing in series through the cells, which circulates through and between the multi-cell heat exchanger and the evaporation column. It is heating up from one cell to the next as it is passing in series through the cells of the heat exchanger, thus gradually decreasing in quantity. The individually quantity- and temperature-adjusted partial flows of salt water transferred from the heat exchanger cells to the evaporation column are adjusted to the enthalpy level of the vapor-saturated partial flows of carrier gas transferred from the evaporation column via the heat exchanger cells to the condensation column. The reheated partial flows of salt water are introduced into the evaporation column at inlet points with approximately the same temperature and thus counteracting the heat losses transferred by the circulating carrier gas. During their passage through the evaporation column, these evaporate together with the main flow of salt water while cooling. The total quantity of circulating salt water to be fed through the heat exchanger cells is fed either from the concentrated brine outflow or from the raw water inflow.

The heat exchange output to be installed for the compensation of the heat losses transferred is thus reduced for a distillate rate of 1000 kg/h of water from 2×210 kW to less than 70 kW. In other words, it is reduced to one sixth of its previous level. Temperature losses are halved.

The different heat exchange outputs required in order to fulfill the same purpose result from the physical condition that, given a fixed total system pressure for the storage of identical quantities of vapor in the carrier gas, a greater quantity of gas is required for storage at low vapor partial pressure than for storage of the same quantity of vapor at a high partial pressure. For this reason, the quantities of carrier gas being transferred from the evaporation column to the condensation column are decreasing exponentially as the saturation temperature rises above the operating temperature range of the columns. The partial quantities of carrier gas that accumulate to form the total quantity in circulation therefore must not, as revealed in the patent specification EP 0531 293 B1, pass through the entire working temperature range of the columns in their entirety. Instead, the largest partial quantity of the carrier gas must only pass through the lowest temperature range, and the smallest partial quantity of the carrier gas must pass through the entire temperature range. In the extreme case, if the partial pressure of the vapor would be equal to the total system pressure, the partial quantity of carrier gas to be transferred would equal zero. Connecting the heat exchanger parallel in accordance with the invention dispenses with the need to integrate heat and mass exchange devices in the columns and means that heat and mass exchange in the columns is less susceptible to losses. The columns are thus more compact and significantly less expensive to manufacture.

Moreover, feeding the concentrate outflow through the multi-cell heat exchanger on the salt-water side more then once is a particularly effective way to concentrate the final outflow to the point of precipitation, however, avoiding crystallization. This is especially advantageous when salt water reserves are limited or when producing highly concentrated brine as a chemical raw material from the unlimited seawater supply.

The salt water circulating between the multi-cell heat exchanger and the evaporation column is not only compensating the heat losses transferred by the circulating carrier gas; it is also gradually replacing the evaporating salt water in the evaporation column and equalizing the enthalpy changes of the evaporating salt water. As a result, the specific evaporation quantity in the evaporation column is increasing as the evaporation temperature is decreasing, whereas without the circulating salt-water it would decrease. Consequently, the specific reheating requirement for obtaining the distillate is lower.

Another aspect of the process involved in the invention is the fact that the multi-cell heat exchanger is combined with the recuperation device in the condensation column or integrated in the column, and the heat exchange surface of the recuperation device is enlarged by zones to include the performance values of the individual heat transfer cells of the external heat exchanger, and that quantity- and temperature-adjusted partial quantities of raw water are removed from the recuperation device in stages and fed to locations in the evaporation column having the same temperature. As a result, the columns can be manufactured as evaporation modules with a space- and cost-saving coaxial design, and with an outer casing that is capable of withstanding pressure. This substantially reduces the costs for piping, valves and pressure vessels as well as for pipe connectors and minimizes the use of expensive sea water-resistant materials.

An unlimited number of these evaporation modules can be connected in parallel groups to increase drinking water production capacity and connected in series with up to 4 operational system pressure levels. With different system pressure levels, the quantities of carrier gas circulating in the evaporation modules at lower system pressure levels are reduced, as is the associated heat transfer. In addition, the evaporation temperature range can thus be increased to up to 220 K., and the waste heat of the modules at a higher system pressure level can be used to finally heat the salt water inflow of the evaporation modules at the system pressure level below it. As a result, this reduces the external heating performance at the highest system pressure level and the external cooling performance at the lowest system pressure level. With an enlarged evaporation temperature range, specific thermal energy consumption for the production of drinking water from raw water, regardless of its salt content, can be reduced to less than 10 kWh/m³. Moreover, the modular design permits larger and thus more cost-effective production lots in largely automated production plants.

Ideally, the operational system pressure levels of the evaporation modules should be selected so that in the series-connected modules identical evaporation temperature differences are processed with adjusted specific evaporation rates that build on each other and thus extend the total evaporation temperature range of the evaporation plant. The total system pressures in the evaporation modules are set by means of the carrier gas filling quantities. The operating values at the different system pressure levels are not reached until the upper evaporation temperature determined by the external heat source is reached. The best carrier gas for evaporation plants for obtaining drinking water is ambient air.

It is always advantageous for an evaporation plant to have a mechanical filter on the raw water inflow side to remove suspended matter from the raw water. Salt water from the concentrate outflow or a second body of raw water employed as a coolant for the evaporation plant can be used to good effect for automatic backwashing.

For multistage evaporation plants with evaporation temperatures of over 100° C., the integration of a selectively clarifying electro-dialysis unit for the raw water inflow is recommended in order to prevent encrustation forming on the evaporation surfaces. This is an energy-saving method of removing crust-forming and corrosive dissociated salts such as CaSO₄, CaCO₃ and Mg(OH)₂ from the raw water to be heated up and of bypassing the evaporation plant to feed them to the concentrate or coolant outflow of the evaporation plant. This increases availability and service life of the evaporation plant and minimizes the required maintenance.

Solar heat or the waste heat of industrial processes can be used very effectively to reheat the clarified, preheated raw water up from the recuperative final temperature to the upper evaporation temperature. For solar heating, the operating pressure levels of the evaporation modules can be set to the optimum collector operating conditions.

The waste heat from power-generating gas turbines or combustion engines is particularly suitable. In this case, the number of in parallel- and in series-connected evaporation modules can be adjusted to the temperature level and the amount of waste heat supplied. The power-generating component of a plant like this provides all of the power required by the plant as a whole, and for example, can feed surplus energy into a public power grid. In plants of this kind, fuel utilization rates of up to 85% are possible.

To increase drinking water production, reverse osmosis (RO) and/or electro-dialysis (ED) plants can be connected to these plants in upstream or in parallel on the raw-water inflow side. However, this is only worthwhile, if the specific energy consumption including conversion losses is not higher than that of the evaporation plant itself. It is always advantageous when the salt concentration of the raw water to be fed in changes at intervals, for example as a result of the effect of tides when raw water is taken from river estuaries.

The distillate obtained using an evaporation plant like this can be blended with a portion of the pretreated raw water and/or with permeates of the mechanical or electrical processes to produce drinking water (RO, ED). These pass through an ultraviolet radiation system (UVR) to sterilize them before they are mixed with the distillate.

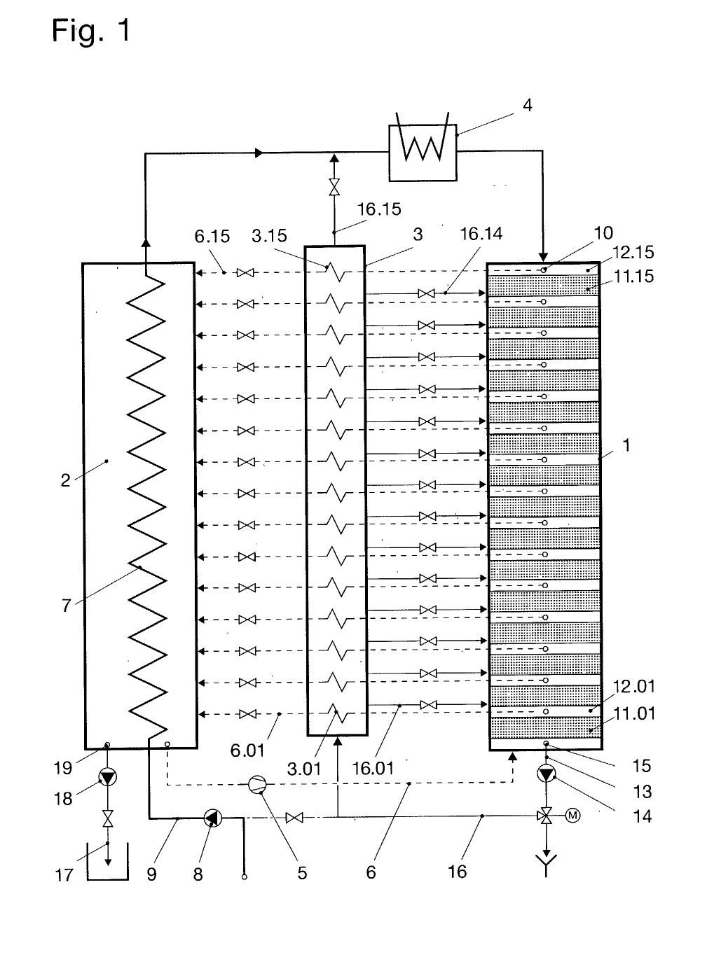

The invention is described in more detail using FIGS. 1 to 5. The figures illustrate the following:

FIG. 1: The diagram of the process of a single-stage evaporation module with a multi-cell heat exchanger outside the columns to compensate for the heat losses transferred by the circulation of the carrier gas.

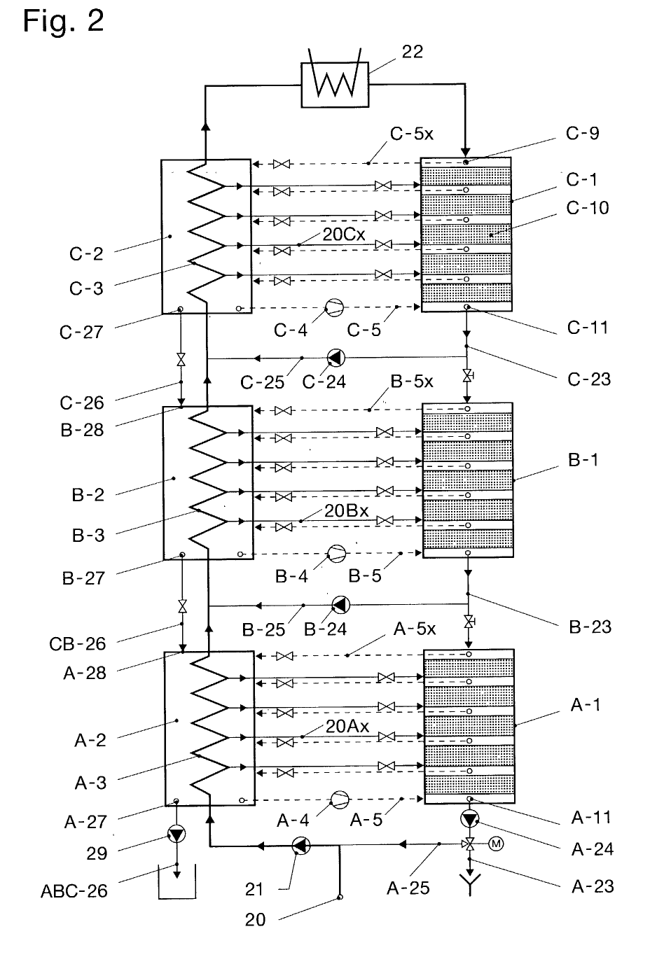

FIG. 2: The diagram of the process of an evaporation system consisting of three operational system pressure levels with an evaporation module at each of the system pressure levels and with the systems combined with the recuperation units for compensating the heat transfer.

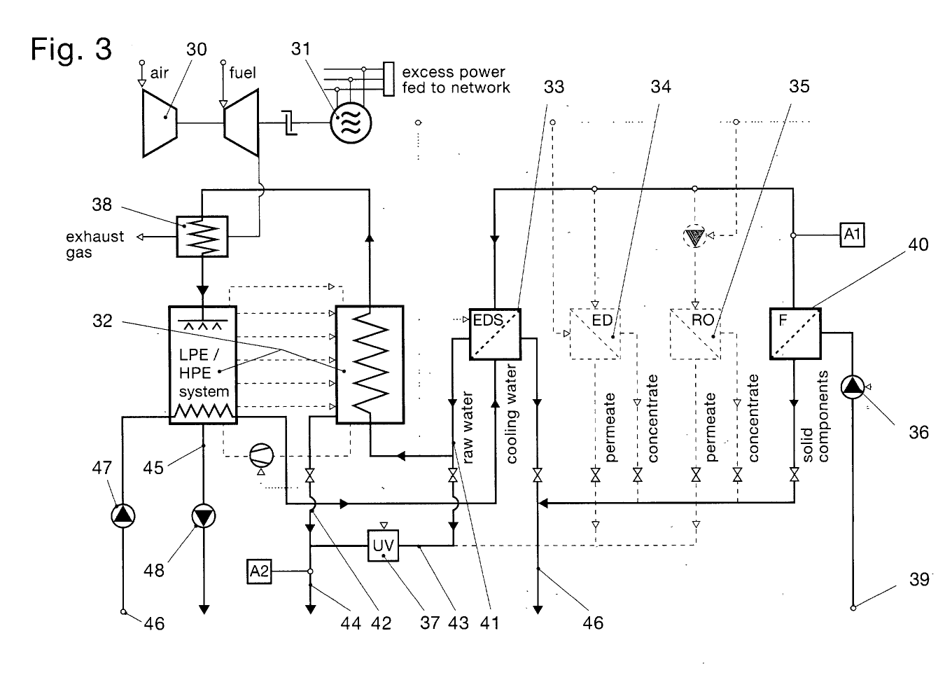

FIG. 3: The block diagram for the process of an evaporation plant heated by waste heat of a power generation plant for the combined production of drinking water, high-grade brine and generation of electric power.

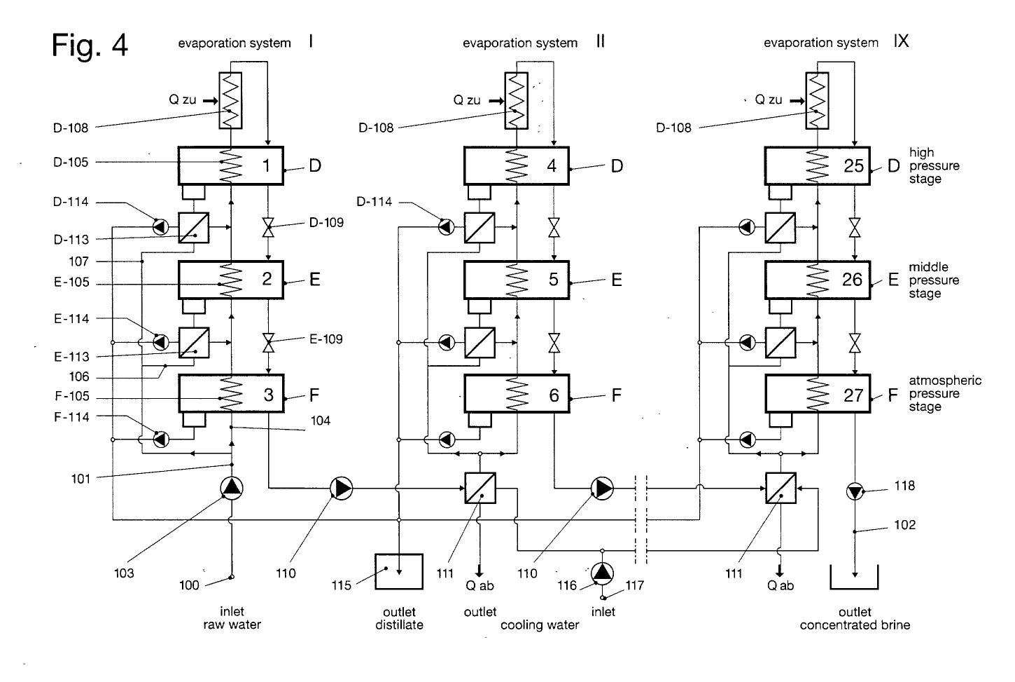

FIG. 4: The raw water flow diagram of an evaporation plant for the production of high quality drinking water and high-grade brine.

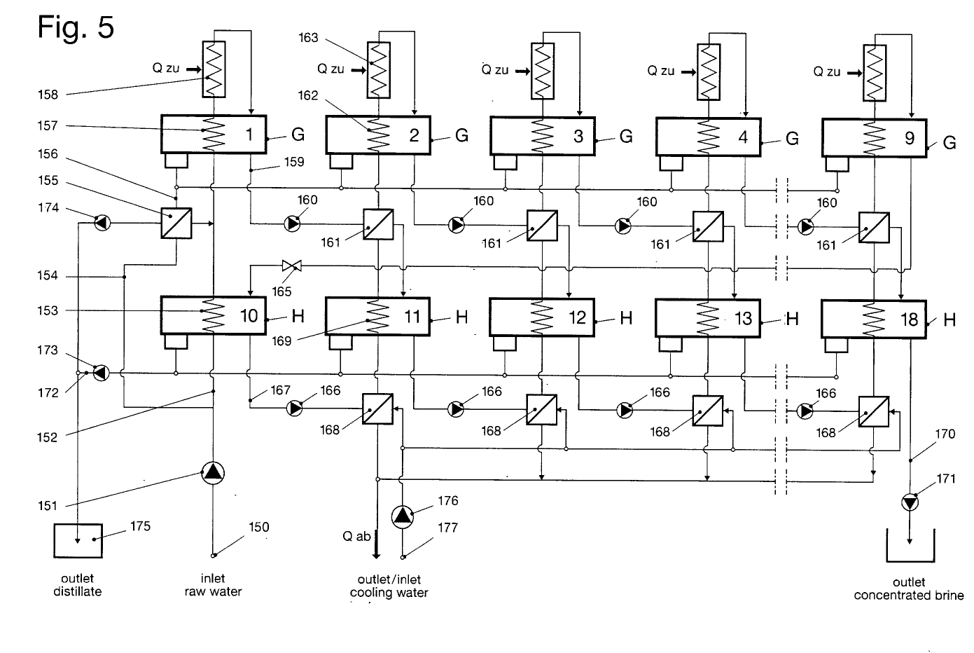

FIG. 5: An alternative raw water flow diagram of an evaporation plant for producing high quality drinking water and high-grade brine with optimized energy consumption values.

FIG. 1 illustrates the evaporation module consisting of an evaporation column (1), a condensation column (2), a multi-cell heat exchanger (3) and a reheating facility (4). The vapor-collecting carrier gas (6), in this case air, is circulating between and through the columns (1) and (2) propelled by a blower (5).

A recuperative heat exchange device (7) is located in the condensation column (2). The pump (8) is propelling the raw water (9) through the heat exchange device (7) for recuperative reheating. The recuperatively heated raw water (9) is fed through the reheating facility (4), in which it is heating up to the upper evaporation temperature and it is then introduced at the top (10) of the evaporation column (1).

The evaporation column (1) is containing heat and mass exchange packings arranged one above the other (11.01 to 11.15) through which the heated raw water (9) is passing vertically from top to bottom, while evaporating into the air flow in the opposite direction (6) and cooling on the way down. There are free spaces (12.1 to 12.15) between the packings (11.01 to 11.15). From these, vapor-saturated partial flows (6.01 to 6.15) are fed into the circulating air (6) through the separated cells (3.01 to 3.15) of the multi-cell heat exchanger (3) and then introduced into the condensation column (2) at the same temperature level. The air is passing through an identical number of units (11.01 to 11.15) in column (1) and of heat exchanging cells (3.01 to 3.15).

A pump (14) is drawing off the cold concentrated brine (13) from the bottom (15) of the evaporation column (1). The partial salt water flow (16), i.e. of the concentrate outflow (13), is fed to the multi-cell heat exchanger (3), where it resembles the total flow. It is heating up while passing through the cells (3.01 to 3.15) on the secondary side. Between every two cells, an incrementally heated partial flow (16.01 to 16.15) of the circulating salt water (16) is fed back from the multi-cell heat exchanger (3) to the evaporation column (1). The last heated partial flow (16.15) is merging with the recuperatively heated raw water (9) and then fed into the reheating unit (4). The transferred partial flows of salt water (16.x) and the transferred vapor-saturated airflows (6.x) with the same sequence number (x) in each case are equalized in terms of the enthalpy level.

The pump (18) of the evaporation module is drawing off the distillate (17) from the bottom (19) of the condensation column (2) for further use. The number of partial flow transfers in an evaporation module depends on the total system pressure and the temperature range in the columns.

FIG. 2 illustrates the multistage evaporation system consisting of three evaporation modules (A, B, C) operating at different pressure levels. Each evaporation module contains an evaporation column (A-1, B-1, C-1) and a condensation column (A-2, B-2, C-2). The condensation columns (A-2, B-2, C-2) contain the associated recuperative heat exchange devices (A-3, B-3, C-3) for preheating the raw water.

The vapor-saturated airflow (A-5) propelled by the blower (A-4) circulates between and through the columns (A-1) and (A-2). In evaporation modules B and C, the saturated airflows (B-5) and (C-5) circulate in the same way as in module A. The operating pressures in the evaporation modules (A, B, C) are adapted to the different evaporation temperature ranges, which complement each other.

The pump (21) is propelling the raw water (20) through the recuperation devices (A-3, B-3, C-3) and where it is heating up to the final recuperative temperature. The heated raw water (20) is then fed through the reheating facility (22), where it is heating up to the upper evaporation temperature, before being introduced at the top (C-9) of the evaporation column (C-1).

While evaporating in the vapor-collecting airflow (C-5) running in the opposite direction and while constantly cooling, the raw water (20) is passing through the heat and mass exchange packings (C-10). At the bottom (C-11) of the column (C-1) the partially evaporated raw water (C-23) is drawn off from the evaporation column (C-1), its pressure is reduced in a throttle-valve to that of the evaporation module (B) and it is introduced at the top (B-9) of the column (B-1). The partially evaporated salt water (C-23) is passing through the columns (B-1) and (A-1) successively, while the system pressure is reduced incrementally and evaporation and cooling continues, as in column (C-1). The final concentrate (A-23) is drawn off from the atmospheric evaporation module (A) out of the bottom (A-11) of the evaporation column (A-1) by the pump (A-24) and passed on for further processing.

From the recuperative heat exchange devices (A-3, B-3, C-3), as shown in FIG. 1 for the multi-cell heat exchanger (3), enthalpy-adjusted partial flows of salt water (A-20x, B-20x, C-20x) are fed in the opposite direction to the individual, vapor-saturated partial flows of air (A-5x, B-5x, C-5x) transferred from the evaporation columns (A-1, B-1, C-1) to the condensation columns (A-2, B-2, C-2). They are then introduced into the evaporation columns (A-1, B-1, C-1) at the same temperatures at the corresponding locations.

The salt water (A-25, B-25, C-25) circulating between the heat exchange devices (A-3, B-3, C-3) and the evaporation columns (A-1, B-1, C-1) is fed separately for each evaporation stage (A, B, C) by the pumps (A-24, B-24, C-24) from the respective concentrate outflows (A-23, B-23, C-23) to the raw water (20) at the appropriate points, before entering the recuperative heat exchange devices (A-3, B-3, C-3).

The distillate portion (C-26) condensing from the saturated airflow (C-5) in the condensation column (C-2) is cooling as it is passing through the condensation column (C-2) from top to bottom. It is collected at the bottom (C-27) where a throttle-valve reduces its pressure and introduced at the top (B-28) of the condensation column (B-2) where it is cooling with the distillate portion (B-26) condensed out of the vapor-saturated airflow (B-5). The merged distillate portion (CB-26) is collected at the bottom (B-27).

The distillate portion (CB-26) is reduced to the system pressure level of the condensation column (A-2) and introduced at the top of it (A-28). The distillate portion (CB-26) is merging with the distillate portion (A-26) condensed out of the vapor-saturated airflow (A-5) and cooling off together with it while flowing from top to bottom in the condensation column (A-2). The distillate (ABC-26) collecting at the bottom (A-27) is extracted from the condensation column (A-2) by the pump (29) for further use.

The drawing in FIG. 3 shows a complete thermal plant based on the evaporation principle for obtaining high quality drinking water from salt water in its most favorable form. This plant produces electricity, high-quality drinking water and high-grade brine. The evaporation modules are only shown in a simplified form. Shown in broken lines are possible enhancements (RO-, ED-units) to the plant, which can increase the drinking water production using surplus energy.

The concept of the plant is based on using the waste heat of a power-generation gas turbine (30) whose generator (31) supplies the necessary power for the evaporation plant (32) and the in series- and parallel-connected current consumers EDS (33), ED (34), RO (35), the feed pumps (36, 45, 47) and the UVR sterilization unit (37). Any surplus energy can be fed into an existing power grid. In a multistage evaporation plant (32) the exhaust-gas heat exchanger (38) is reheating the previously heated raw water (41) using the waste heat of the gas turbine (30).

The untreated raw water (39) is fed through the filter unit (40) by the pump (36) to remove suspended matter and is then freed of the crust-forming, dissociated salts in the selectively clarifying electro-dialysis unit (33) against the flow of the coolant outflow (46) of the evaporation plant. The so pretreated raw water is heating while (41) passing through the recuperation devices in the condensation section of the plant. The water vapor is liquefied and heated to the upper evaporation temperature in the exhaust-gas heat exchanger (38) using the exhaust heat from the gas turbine before it is introduced into the evaporation section of the plant.

The distillate (42) is drawn off from the condensation section of the plant. The brine pump (48) removes the concentrated brine (45) from the evaporation section. The cooling-water pump (47) sends the cooling water (46) through the cooling systems of the evaporation plant and through the secondary side of the electro-dialysis unit (33). The cooling water is also used for filter backwashing and then passed on to waste water disposal. The tasks of the cooling water can also be performed by the concentrate outflow of an in series or in parallel connected RO plant.

The distillate (42) is blended with the partial flow (43) of the pretreated raw water (41) to form high-quality drinking water (44) and then channeled off for usage. The pretreated partial flow of raw water (43) used for blending is passing through the UVR sterilization unit (37) and then blended with the distillate (42).

FIG. 4 shows a raw water-flowchart of a process for the combined production of drinking water with the quality of distillate and high-grade brine as a chemical raw material. Both products are obtained from raw water, regardless of its initial salt content. The raw water to be treated (100) is passing through in series between the raw water inflow (101) and the brine outflow (102) undergoing constant evaporation in the up to nine evaporation systems (I, II-IX) consisting evaporation modules, which operate at three system pressure levels (D, E, F).

Each system pressure level (D, E, F) is representing one of the 27 evaporation stages (1-27). The salt water is passing in parallel through each evaporation stage (1-27), which can in turn consist of several evaporation modules (as in FIGS. 1 or 2, but not shown here). The total number of evaporation stages (1-27) is determined by the initial and final concentrations of the salt water and by the specific evaporation rates possible in the temperature ranges of the different evaporation stages. The number of evaporation stages (1-27) can range from 10 in the case of single-pressure level atmospheric plants to 30 when there are 3 to 4 system pressure levels (D, E, F). The total number of evaporation modules is independent from the number of system pressure levels (D, E, F). This is determined by the drinking water yield. The number of modules is greatest at the first evaporation stage and least at the last evaporation stage. It decreases by an integral increment from stage to stage in accordance with the distillate yield.

The raw-water pump (103) is feeding the incoming raw water (100) in appropriate quantities through the first evaporation system (I). The main portion of the raw water (104) is flowing through the recuperation unit (F-105) warming up by absorbing the heat of the liquefying process when the distillate is obtained. It is then merging again with the portion (106) used for distillate cooling of the middle system pressure level (E), and together with this it is flowing through the recuperation unit (E-105) warming up by absorbing the heat of the liquefying process when the distillate is obtained. It is then merged with the portion (107) used for the distillate cooling of the upper system pressure level (D), and together with this it is flowing through the recuperation unit (D-105) warming up by absorbing the heat of the liquefying process when the distillate is obtained. After leaving the upper recuperation device (D-105), the entire flow of raw water is heated using external energy to the upper evaporation temperature of the upper system pressure level (D) in the heat exchanger (108) and then fed into the evaporation stage as in FIGS. 1 or 2 (not shown) of this system pressure level (D). It is flowing through the evaporation modules of this system pressure level (D) while evaporating and cooling, and its pressure is then reduced by the throttle-valve (D-109) at the outlet to the system pressure of the evaporation stage at the system pressure level (E), which works at intermediate system pressure. It is then flowing through the evaporation modules of this system pressure level (E) and while evaporating and cooling, its pressure is reduced at the outlet by the second throttle-valve (E-109) to the system pressure of the lower system pressure level (F). It is then fed into the lower evaporation stage and flowing through the evaporation modules while evaporating and cooling again. The partially concentrated salt water flowing depressurized out of the first evaporation system (I) is fed by the pump (110) through the external cooled heat exchange facility (111), where it is cooling off to a defined level by a second raw water flow (112) and fed through the second evaporation system (II) in the same way and recuperatively heated, as described in detail for the raw water fed into the first evaporation system (I). The water is then flowing in the same way through the subsequent evaporation systems (III to IX) until high-grade brine is obtained (102).

The distillate of the higher system pressure levels (D, E) is collected from evaporation system to evaporation system and is used in associated distillate coolers (D-113, E-113) to heat the demand-oriented partial quantities of salt water (106, 107) tapped off as required from the main raw water flow (101) up to the upper evaporation temperature of the system pressure level below it (E, F). The partial flows tapped off (106, 107) are merged again with the main raw water flow (104) after being heated up. Consequently, the quantity-related and thermal conditions are always well balanced at the system pressure levels (D, E, F) and at the same system pressure levels of the subsequent evaporation systems (II to IX).

The distillate pumps (D-114), (E114), (F114) assigned to the different system pressure levels (D, E, F) deliver the distillate from the evaporation systems to a drinking water pressure storage (115). The cooling-water pump (116) feeds the raw water (117) through the coolers (111) as a coolant. The concentrated brine (102) is delivered from the last evaporation stage (27) by a pump for further processing.

FIG. 5 shows a drawing of an energy-optimized plant for producing high quality drinking water and high-grade brine with extremely low mechanical energy requirements for salt water pumping. In the sample case shown, there are up to 18 evaporation stages on two operational system pressure levels (G, H), with the first nine evaporation stages at the upper system pressure level (G) and the second nine evaporation stages at the lower system pressure level (H).

The raw water pump (151) is delivering the incoming raw water (150) to the upper system pressure level (G). The main portion of the raw water (152) is warming up passing through the recuperation device of the tenth evaporation stage (10). An adjusted portion of the salt water (154) is passing through the distillate cooler (155) heating up to the upper evaporation temperature of the lower system pressure level (H) in a counter flow by the distillate (156) collected at the upper system pressure level (G). The two preheated partial flows of raw water (152, 154) are then merging. The merged flow (150) is warming up while passing through the recuperative unit (157) of the first evaporation stage (1) at the upper system pressure level (G).

The heating facility (158) is heating the raw water (150) to the upper evaporation temperature of this evaporation stage (1). The raw water is then fed into the evaporation modules (not shown) as in FIG. 1. It is flowing through the evaporation stage, while evaporating and cooling. The pump (160) is delivering the partially concentrated salt water outflow (159) from the first evaporation stage (1) through the heat exchange facility (161) for cooling and stabilization of the lower evaporation temperature at the second evaporation stage (2), which is at the same pressure. The salt water (159) is then heating up, passing through the recuperation device (162) and the external heating facility (163) of the second evaporation stage (2), and it is fed into the evaporation modules (not shown) as in FIG. 1 of this evaporation stage (2) at the upper evaporation temperature.

Further pumps (160) deliver the salt water outflows of the subsequent evaporation stages (3) to (8), which are also at the same pressure, from evaporation stage to evaporation stage in the same way through the upper system pressure level (G), and the salt water outflows are subjected to the thermal treatment described. The pressure of the salt water outflow (164) of the ninth evaporation stage (9) is reduced by a throttle-valve (165) to the system pressure of the lower system pressure level (H) and fed into the tenth evaporation stage (10) without any further heating. The pump (166) is delivering the salt water outflow (167) of the tenth evaporation stage (10) through the cooling facility (168). The salt water (167) is then heating while passing through the recuperation device (169) of the eleventh evaporation stage (11), which is operating at the same pressure level, and the heat exchanger (161). At the upper evaporation temperature of the lower system pressure level (H), the salt water (167) is fed into the evaporation modules (not shown) of the eleventh evaporation stage (11). Further pumps (166) are delivering the subsequent salt water outflows from one evaporation stage to another, and the salt water outflows are subjected to the thermal treatment described. The brine pump (171) is delivering the highly concentrated brine (170) for further processing. The distillate (152, 172) of the two system pressure levels (G, H) is fed into the drinking water pressure storage (175) by two pumps (173, 174). The cooling-water pump (176) supplies the coolers (168) at the lower system pressure level (H) with a second flow of raw water (177), which is passed to waste water disposal after being heated up.

In the flow chart shown in FIG. 5, only the raw water pump (151), the distillate pump (153) and the brine pump (171) have to overcome system pressure differences, while the pumps (160, 166) and the cooling-water pump (176) only have to overcome delivery heights and flow pressure losses in the plant.

1. Evaporation process and facility for obtaining high-quality drinking water from raw water regardless of its initial salt content, as in FIG. 1, consisting of an evaporation column (1), a condensation column (2), an external reheating facility (4) and a vapor-collecting circulatory flow of carrier gas (6), whereby a blower (5) is propelling the saturated carrier gas (6) at a constant pressure over a temperature range in incremental temperature and quantity steps (6.01, 6.15), thus circulating the carrier gas through and between the evaporation column (1) and the condensation column (2), whereby inside the condensation column (2) raw water (9) is passing through a recuperative heat exchange device (7), characterized by the following: that there is a heat exchanger (3) comprising several cells (3.01, 3.15) between the columns (1, 2); that a specifically assigned vapor-saturated transfer flow of carrier gas (6.01, 6.15) is passing through each one of these heat exchanger cells (3.01, 3.15) on the primary side; that salt water (16) from the raw water inflow (9) or from the concentrated brine outflow (13) is passing through the heat exchanger cells (3.01, 3.15) in series on the secondary side, circulating through and between the multi-cell heat exchanger (3) and the evaporation column (1) while being reduced in steps from cell (3.01) to cell (3.15) in its quantity (16.01, 16.15), and, as a result of being heated up in the multi-cell heat exchanger (3), counteracting the heat losses that are being transferred by the partial flows of carrier gas (6.01, 6.15) from the evaporation column (1) to the condensation column (2); that the partial flows of the salt water (16.01, 16.14) obtained from the heat exchanger (3) in incremental temperature and quantity steps are being transferred to locations with the same temperature (12.01, 12.15) in the evaporation column (1); that the partial flow (16.15) merged with the heated raw water (9) coming from the recuperative heating device (7) after passing through the external reheating facility (4) is entering the heat and mass exchange packings (11.15, 11.01) in the evaporation column (1), thus evaporating and cooling while merging with the incoming partial flows of the salt water (16.01, 16.14) obtained from the heat exchanger (3) in incremental temperature and quantity steps, and a pump (14) is transporting the concentrated brine (13) out of the evaporation column (1) and a partial salt water flow (16) again into the multi-cell heat exchanger (3).

2. Process and facility in accordance with claim 1, characterized by the following: that the multi-cell heat exchanger is combined with the recuperation device in the condensation column through which salt water is flowing, or alternatively, integrated in the column as a separate unit; and, that from this combination or separate unit, incrementally quantity-adjusted and incrementally heated partial flows of salt water are being drawn off and fed into the evaporation column at locations having the same temperature.

3. Facility in accordance with claim 1 or claim 2 characterized by the following: that the evaporation column and condensation column are combined in a space-saving and reasonably priced unit, preferably with a coaxial/cylindrical design, placing the evaporation column in the center, and only the outer wall of the unit having to be capable of withstanding system pressures.

4. Process and facilities in accordance with claims 1, claim 2 or claim 3 characterized by the following: that a gas that does not chemically react with the salt water is being used as the carrier gas, preferably air.

5. Process and facility in accordance with claim 1, claim 2, claim 3 or claim 4 characterized by the following: that individual evaporation modules or groups of evaporation modules connected in parallel form evaporation stages; that salt water is passing through up to 30 of these evaporation stages in series and that the salt water in the evaporation modules is warming up recuperatively over a temperature range while condensing vapor and then cooling down over the same temperature range while evaporating.

6. Process in accordance with claim 5 characterized by the following: that the evaporation modules of all evaporation stages work at the same pressure, preferably at atmospheric system pressure, or that the evaporation stages work at up to three system pressure levels arranged one above the other, and that the specific evaporation rates of the evaporation modules are adjusted by means of evaporation temperature ranges complementing each other at the different system pressure levels.

7. Process and facility in accordance with one of claims 5 or 6 characterized by the following: that the number of evaporation modules in the evaporation stages passed through in parallel by salt water from evaporation stage to evaporation stage decreases by an integral increment in accordance with the distillate yield.

8. Process in accordance with claim 7 characterized by the following: that the number of evaporation modules working at the individual system pressure levels is identical or adjusted to suit the external heat available at the relevant system pressure level and increases by an integral increment from the upper system pressure level, via the intermediate levels to the lower level.

9. Process in accordance with claim 6, claim 7 or claim 8 characterized by the following: that a throttle-valve is reducing the pressure of a salt water outflow from an evaporation stage of a higher system pressure level to the evaporation stage of the next lower system pressure level and this salt water outflow is being fed unheated into the evaporation modules of this lower system pressure level.

10. Process and facilities in accordance with claim 9 characterized by the following: that the total system pressures selected at the system pressure levels are set by means of the carrier-gas filling levels, and that the operating pressure values are set when the respective upper evaporation temperatures are reached.

11. Process and facility in accordance with claim 10 characterized by the following: that, on the salt water side, up to three evaporation stages working at different system pressures are passed through in series; that the salt water is successively passing through the recuperation devices of the evaporation stages at different pressure levels in the direction of increasing system pressure, and, before being transferred to the evaporation stage of the upper system pressure level, is being heated using external energy to reach the upper evaporation temperature of this system pressure level, passing through it, thus evaporating and cooling; that, as it is flowing out, its pressure is being reduced in a throttle-valve to the lower middle system pressure of the next evaporation stage down; that it is then passing through this as well as the evaporation stage of the system pressure level below it in the same manner without being reheated; and that it is flowing out of the lower evaporation stage, preferably at atmospheric pressure, while the distillate from the higher system pressure levels is being collected, and adjusted partial quantities of the salt water in associated distillate coolers are being heated to the upper evaporation temperature of the following lower system pressure level.

12. Process for obtaining sterile, high-quality drinking water and valuable, virtually saturated brine from raw water regardless of its initial salt content in accordance with claim 11 characterized by the following: that up to twenty single-stage evaporation systems operating at atmospheric system pressure level, or up to twenty-five two-stage evaporation systems operating at two system pressure levels, or up to thirty three-stage evaporation systems operating at three system pressure levels are connected in series on the salt water flow side; that pumps are feeding the depressurized, partially concentrated salt water outflows from the lowest system pressure level of an evaporation system to the highest system pressure level of the next evaporation system; and that these salt water flows are previously cooled to a defined temperature in a heat exchanger in each case by means of an external coolant, preferably with a second body of raw water, before passing through the recuperation devices of the next single- or multi-stage evaporation system.

13. Process for obtaining sterile, high-quality drinking water and valuable, virtually saturated brine from raw water regardless of its salt content characterized by the following: that the raw water to be treated is in series passing through at least 10 and at the most 30 evaporation stages consisting of evaporation modules in parallel; that the number of evaporation modules passed through by the salt water decreases from one evaporation stage to the next, depending on the distillate yield; that each of the partially concentrated salt water quantities transferred from one evaporation stage to the next is being previously cooled to a defined temperature before entering the recuperation devices located in the condensation sections of the following evaporation modules, while the inflowing raw water is passing through the recuperation devices without being previously cooled; and that all of the preheated salt water flows emerging from the recuperation units are reheated in a heating facility to the upper evaporation temperature before being transferred to the evaporation sections in the same evaporation modules.

14. Process in accordance with claim 13 characterized by the following: that the first evaporation stage with the raw water inflow is located at the beginning of the highest system pressure level; that the last evaporation stage with the final, concentrated brine outflow is located at the end of the lowest system pressure level; that the raw water, while heating and without previous cooling, beginning at the lowest system pressure level and ending at the highest system pressure level, is passing through a number of recuperative heat exchange devices in parallel; that the first evaporation stage determines the number of evaporation modules being passed through in parallel; and that, at the system pressure levels under this, the salt water is passing through either the recuperation devices of two evaporation stages or the recuperation devices of the evaporation modules of one evaporation stage, and in addition to this an adjusted number of one or two distillate coolers in parallel.

15. Process in accordance with claim 14 characterized by the following: that the salt-water outflows of the remaining evaporation stages at a higher system pressure level are reheating the recuperatively preheated salt water inflows of the evaporation stages of the next system pressure level to the upper evaporation temperature of this system pressure level, while cooling to a defined temperature in a heat exchanger unit, so that only the evaporation modules not passed through by the salt water at the lowest system pressure level are being externally cooled and only the salt water inflows of the evaporation units are being heated in a heating facility using external energy at the highest system pressure level.

16. Process in accordance with claim 15 characterized by the following: that a pump is propelling the raw water into the first evaporation stage at the highest system pressure level overcoming the differences in system pressure; that low-pressure pumps are propelling the salt-water outflows (minus the distillate quantities of the evaporation stages) of the evaporation stages operating at the highest system pressure level from one evaporation stage to the next; that a throttle-valve is reducing the pressure of the salt water flowing out from the highest system pressure level to the next system pressure level down; that low-pressure pumps are propelling the salt-water outflows (minus the distillate quantities) of the evaporation stages operating at this system pressure level from one evaporation stage to the next; that this energy-saving way of delivering the salt water outflows continues until the concentrated brine is obtained at the end of the lowest system pressure level; that each evaporation stage is allocated a low-pressure pump; and that these pumps only compensate for delivery height differences and flow pressure losses within the plant.

17. Process and facility in accordance with one of the above claims 1 to 16 characterized by the following: that the recuperatively preheated salt water is reheated to its upper evaporation temperature using solar heat or process heat, preferably exhaust heat from thermal power-generation processes, such as from gas-turbine generators or combustion engines; and that evaporation systems with one, two or three system pressure levels can be combined in order to optimize the use of such external heat sources.

18. Process and facilities in accordance with claim 17 characterized by the following: that a selective electro-dialysis system and/or a mechanical filtration system are connected upstream for the raw water inflow of the evaporation plant; that the filtration system is removing suspended matter from the raw water; and that the selective electro-dialysis system is being used preferably to transfer crust-forming, corrosive and dissociative salts from the raw water inflow of the evaporation plant to a second raw water flow, which is being used as a coolant for the evaporation plant.

19. Process and facilities in accordance with claim 18 characterized by the following: that an RO- and/or ED-desalting unit is connected to the thermal desalting plant in series or in parallel on the raw water inflow side; and that this unit uses surplus energy to produce an additional quantity of permeate.

20. Process and facilities in accordance with claim 19 characterized by the following: that the permeate obtained is sterilized by means of ultraviolet radiation (UVR) and then blended with the distillate of the evaporation plant to achieve high-quality drinking water
